(19) United States
(12) Patent Application Publication
(10) Pub. No.: US 2012/0052229 A1
(43) Pub. Date: Mar. 1, 2012

(54) THERMOSETTING ADHESIVE TAPE OR SHEET

(75) Inventors: Rie Kuwahara, Ibaraki-shi (JP); Hakaru Horiguchi, Ibaraki-shi (JP)

(73) Assignee: NITTO DENKO CORPORATION, Ibaraki-shi (JP)

(21) Appl. No.: 13/216,520

(22) Filed: Aug. 24, 2011

(30) Foreign Application Priority Data
Aug. 31, 2010 (JP) 2010-194477

(51) Int. Cl. B32B 33/00

(52) U.S. Cl. 428/41.8

(57) ABSTRACT

Provided is a thermosetting adhesive tape or sheet resistant to deposition of foreign matter such as dust and dirt to the thermosetting adhesive layer surface.

An adhesive tape or sheet for a flexible printed circuit board including a thermosetting adhesive layer, and a release liner on at least one surface of the thermosetting adhesive layer, wherein the arithmetic mean roughness (Ra) of the at least one surface of the release liner is 0.6 μm or more and less than 20 μm and the surface (at least one surface) of the release liner having an arithmetic mean roughness (Ra) of 0.6 μm or more and less than 20 μm is in contact with the surface of the thermosetting adhesive layer.

### TECHNICAL FIELD

The present invention relates to a thermosetting adhesive tape or sheet having a thermosetting adhesive layer. More specifically, it relates to a thermosetting adhesive tape or sheet for use in application for adhesion of a flexible printed circuit board.

### BACKGROUND ART

Flexible printed circuit boards (hereinafter, referred to briefly as “FPCs”) have been used widely in electronic devices. In such a FPC, an adhesive agent is used, for example, (1) in the process of producing a FPC by adhering and laminating a conductive metal foil such as copper foil or aluminum foil to a heat-resistant base material such as polyimide base material or polyamide base material and (2) in the process of adhering a FPC to a reinforcing plate such as aluminum plate, stainless steel plate or polyimide plate.

Examples of the adhesive agents that have been used for adhesion of FPCs are adhesive agents in the configuration of an, elastomer/a resol-type phenol resin crosslinking agent (see Patent Document 1). Other examples include adhesive agents in the configuration of elastomer/epoxy resin/epoxy resin curing agent (see Patent Document 2).

### CITATION LIST

### Patent Literature

Patent Document 1: Japanese Unexamined Patent Publication No. 2005-239830
Patent Document 2: Japanese Unexamined Patent Publication No. 2002-275444

### SUMMARY OF INVENTION

### Technical Problem

The thermosetting adhesive layer formed with the adhesive agent shows adhesiveness at normal temperature. Thus, such a thermosetting adhesive tape or sheet having such a thermosetting adhesive layer had a problem of deposition of foreign matter such as dust and dirt to the surface of the thermosetting adhesive layer during operations conducted as the thermosetting adhesive layer is exposed, such as operation to adhere a FPC to a reinforcing plate such as aluminum plate, stainless steel plate or polyimide plate, operation to punch a thermosetting adhesive tape or sheet, and operation to punch a thermosetting adhesive tape or sheet carrying a reinforcing plate.

Therefore, an object of the present invention is to provide a thermosetting adhesive tape or sheet resistant to deposition of foreign matter such as dust and dirt to the thermosetting adhesive layer surface.

### Solution to Problem

After intensive studies, the inventors have found it is possible to obtain a thermosetting adhesive tape or sheet resistant to deposition of foreign matter to its thermosetting adhesive layer surface at normal temperature, by preparing an adhesive tape or sheet for a flexible printed circuit board, having a release liner, which is surface-roughened on at least one surface, on at least one surface of a thermosetting adhesive layer, wherein the roughened surface of the release liner and the surface of the thermosetting adhesive layer are brought into contact with each other, and made the present invention.

Specifically, the present invention provides a thermosetting adhesive tape or sheet for a flexible printed circuit board including a thermosetting adhesive layer and a release liner on at least one surface of the thermosetting adhesive layer, wherein the arithmetic mean roughness (Ra) of the at least one surface of the release liner is 0.6 μm or more and less than 20 μm and the surface (at least one surface) of the release liner having an arithmetic Mean roughness (Ra) of 0.6 μm or more and less than 20 μm is in contact with the surface of the thermosetting adhesive layer.

Additionally of the thermosetting adhesive tape or sheet, the 180° peel adhesion to polyimide of the surface of the thermosetting adhesive layer in contact with the surface of the release liner having an arithmetic mean roughness (Ra) of 0.6 μm or more and less than 20 μm, as determined at a tensile speed of 100 mm/minute, is preferably 1 N/2 cm or less.

Further of the thermosetting adhesive tape or sheet, the thermosetting adhesive layer is preferably a thermosetting adhesive layer formed with a thermosetting adhesive composition containing an acrylic polymer (X) and a thermosetting resin (Y).

Further of the thermosetting adhesive tape or sheet, the release force between the release liner and the thermosetting adhesive layer, as determined at a tensile speed of 300 mm/minute, is preferably 0.3 N/5 cm or less.

Further of the thermosetting adhesive tape or sheet, the surface of the thermosetting adhesive layer in contact with the surface of the release liner having an arithmetic mean roughness (Ra) of 0.6 μm or more and less than 20 μm preferably has an arithmetic mean roughness (Ra) of 0.7 μm or more and less than 20 μm.

Further of the thermosetting adhesive tape or sheet, the release liner is preferably a release liner without silicone treatment.

### Advantageous Effects of Invention

Because the thermosetting adhesive tape or sheet of the present invention, which has a release liner having an arithmetic mean roughness (Ra) of at least one surface at 0.6 μm or more and less than 20 μm, has a configuration in which the release liner and the thermosetting adhesive layer are in contact with each other, it is resistant to deposition of foreign matter such as dust and dirt to the surface of the thermosetting adhesive layer. Thus, it shows favorable operability, in particular in operations conducted, as the surface of the thermosetting adhesive layer is exposed, such as operation to bond a FPC to a reinforcing plate, operation to punch a thermosetting adhesive tape or sheet, and operation to punch a thermosetting adhesive tape or sheet carrying a reinforcing plate.

### BRIEF DESCRIPTION OF DRAWINGS

FIG. 1 is a schematic cross-sectional view illustrating an example of the thermosetting adhesive tape or sheet of the present invention (when it is a single separator-type thermosetting adhesive tape or sheet).

FIG. 2 is another schematic cross-sectional view illustrating an example of the thermosetting adhesive tape or sheet of the present invention (when it is a double separator-type thermosetting adhesive tape or sheet).

### DESCRIPTION OF EMBODIMENTS

The thermosetting adhesive tape or sheet of the present invention is a thermosetting adhesive tape or sheet having a release liner (separator) on at least one surface of its thermosetting adhesive layer. The term “thermosetting adhesive tape or sheet,” as used in the present description, means in principle a tape or sheet containing a “release liner”, and the region of the “thermosetting adhesive tape or sheet after separation of the release liner” may be referred to as an “adhesive body”. In addition, the surface of the thermosetting adhesive layer of the adhesive body may be referred to as an “adhesive face”. As used throughout the present specification, the singular forms “a,” “an,” and “the” include plural reference unless the context clearly dictates otherwise.

Thus, the thermosetting adhesive tape or sheet of the present invention is a thermosetting adhesive tape or sheet having a release liner on at least one adhesive face of an adhesive body.

The adhesive body in the thermosetting adhesive tape or sheet of the present invention may be an adhesive body which adhesive on both surfaces (double-sided adhesive body) or an adhesive body which adhesive only on one surface (single-sided adhesive body). In particular, the adhesive body is preferably a double-sided adhesive body from the viewpoint for example of adhesion between a FPC and a reinforcing plate, although it is not particularly limited thereto. When the adhesive body is a double-faced adhesive body, the thermosetting adhesive tape or sheet of the present invention may be a single separator-type thermosetting adhesive tape or sheet having a release liner only on one adhesive face of the adhesive body or a double separator-type thermosetting adhesive tape or sheet having different release liners on both-sided adhesive faces of the adhesive body.

Hereinafter, the release liner essential in the thermosetting adhesive tape or sheet of the present invention will be referred to as “release liner A”.

When the thermosetting adhesive tape or sheet of the present invention is a single separator-type thermosetting adhesive tape or sheet, only one adhesive face of the adhesive body (double-sided adhesive body) is configured to be protected with the release liner A. Specifically, thermosetting adhesive tape or sheet of the present invention has a configuration of “a release liner A/an adhesive body”. In the thermosetting adhesive tape or sheet in the configuration above, the surface of the release liner A in contact with the adhesive body may be referred to as “release face”, while the surface opposite to the release face as “rear release face”. Alternatively, the adhesive face of the adhesive body in contact with the release face of the release liner A may be referred to as “adhesive face a”, and the adhesive face opposite to the adhesive face a as “adhesive face b”.

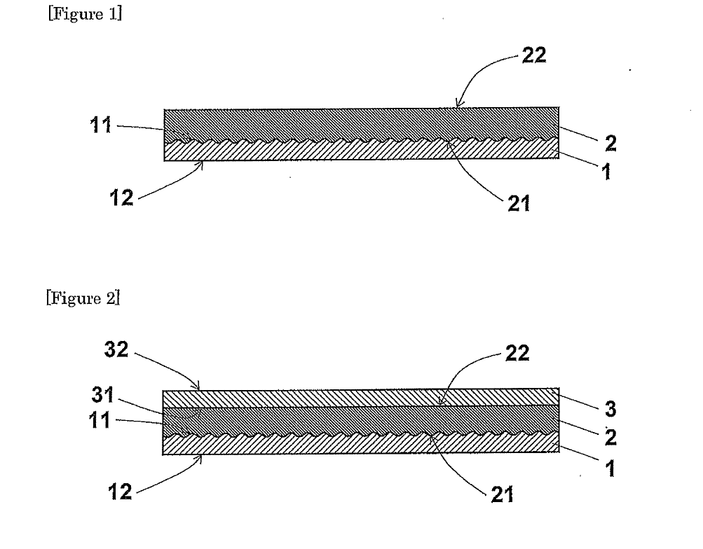

FIG. 1 is a schematic view (schematic cross-sectional view) illustrating the single separator-type thermosetting adhesive tape or sheet. In FIG. 1, 1 represents a release liner A; 11 represents its release face; and 12 represents the rear release face. 2 represents an adhesive body; 21 represents the adhesive face a; and 22 represents the adhesive face b. When the thermosetting adhesive tape or sheet shown in FIG. 1 is wound, the adhesive face b (22) of adhesive body 2 becomes in contact with the rear release face 12 of release liner A (1), and both adhesive faces of the adhesive body are configured to be protected by a single release liner A.

When the thermosetting adhesive tape or sheet of the present invention is a double separator-type thermosetting adhesive tape or sheet, one adhesive face of the adhesive body (double-sided adhesive body) has a release liner A, and the other adhesive face has an another release liner (referred to as “release liner B”). Thus, the thermosetting adhesive tape or sheet of the present invention has a configuration of “release liner A/adhesive body/release liner B”. In the thermosetting adhesive tape or sheet in the configuration above, the surface of each of the release liners A and Bin contact with the adhesive face may be referred to as “release face”, and the surface opposite to each of the release face as “rear face”. In the adhesive faces of the adhesive body, the adhesive face in contact with the release face of the release liner A may be referred to as “adhesive face a”, while the adhesive face opposite to the adhesive face a (i.e., adhesive face in contact with the release face of release liner B) may be referred to as “adhesive face b”.

FIG. 2 is a schematic view (schematic cross-sectional view) illustrating the double separator-type thermosetting adhesive tape or sheet. In FIG. 2, 1 represents a release liner A; 11 represents the release face; and 12 represents the rear face, 3 represents a release liner B; 31 represents the release face; and 32 represents the rear face. 2 represents an adhesive body; 21 represents the adhesive face a; and 22 represents the adhesive face b.

When the adhesive body in the thermosetting adhesive tape or sheet of the present invention is a single-sided adhesive body, the thermosetting adhesive tape or sheet of the present invention has a configuration in which a release liner A is formed on the adhesive face of the adhesive body.

### [Release Liner A]

The arithmetic mean roughness (Ra) of the release face of release liner A in the thermosetting adhesive tape or sheet of the present invention is 0.6 μm or more and less than 20 μm, preferably 0.8 μm or more and less than 18 μm, and more preferably 1.0 μm or more and less than 15 μm. When the arithmetic mean roughness is 0.6 μm or more, the surface of the adhesive face a is roughened easily, suppressing deposition of foreign matter to the adhesive face a. Alternatively, when the arithmetic mean roughness of the release face is less than 20 μm, the release force between the release liner A and the thermosetting adhesive layer does not become too high, thus leading to improvement in processability.

The arithmetic mean roughness (Ra) can be determined in accordance with JIS B0601 (2001). Specifically, it can be determined, for example, by using a contact surface roughness tester (trade name: “P-15”, manufactured by KLA-Tencor Corporation).

When the thermosetting adhesive tape or sheet of the present invention is a single separator-type thermosetting adhesive tape or sheet, the arithmetic mean roughness (Ra) of the rear release face of release liner A is not particularly limited.

When the thermosetting adhesive tape or sheet of the present invention is a double separator-type thermosetting adhesive tape or sheet, the arithmetic mean roughness (Ra) of the rear face of release liner A is not particularly limited.

The thickness of the release liner A is not particularly limited, but preferably, for example, 20 to 200 μm, more preferably 20 to 150 μm. When the thickness is 20 μm or more, the thermosetting adhesive layer surface is roughened easily, thus leading to efficient improvement of Ra of the surface. Alternatively, when the thickness is 200 μm or less, the tape or sheet can be wound without crinkling. When the release liner A has irregularity on the surface, “the thickness of the release liner A” is a thickness, as determined based on the protuberances thereon.

The release liner A is preferably, for example, a non-silicone-based release liner, although it is not particularly limited thereto. Use of a non-silicone-based release liner prevents generation of siloxane gas and contamination of the adherend caused by silicone components derived from a silicone-based release-coating agent, and thus, prevents corrosion or contact point failures and others of electronic parts in FPCs and other products (e.g., hard disk drives) produced by using the thermosetting adhesive tape or sheet of the present invention.

The non-silicone-based release liner is a release liner not silicone-treated (release liner not treated with a silicone-based release-coating agent). Examples of the non-silicone-based release liner include, but are not limited to, release liners having a release layer (release-treated layer), low-adhesiveness release liners composed of a fluorochemical polymer, low-adhesiveness release liners composed of a non-polar polymer and the like. Examples of the release liners having a release layer include plastic films and papers surface-treated with a release-coating agent such as long-chain alkyl-based, fluorine-based or molybdenum sulfide coating agent, and the like. Typical examples of the fluorochemical polymers include polytetrafluoroethylene, polychlorotrifluoroethylene, polyvinyl fluoride, polyvinylidene fluoride, tetrafluoroethylene-hexafluoropropylene copolymers, chlorofluoroethylene-vinylidene fluoride copolymers and the like. Typical examples of the non-polar polymers include polyolefin resins (e.g., polyethylene, polypropylene) and the like.

In particular, the non-silicone-based release liner is preferably a release liner having a release layer composed of a polyolefin resin (polyolefin-based release liner), more preferably a release liner having a release layer composed of polyethylene (polyethylene release liner). More specifically, it is, for example, a release liner having a polyolefin resin laminate layer formed on a plastic film (preferably polyester film, more preferably polyethylene terephthalate film), paper or the like. The surface of the polyolefin-based release liner in contact with the thermosetting adhesive layer is preferably configured to be a polyolefin resin. Thus, when the release liner A is a polyolefin-based release liner, the surface of the release layer made of a polyolefin resin is used as the release face and the rear release face described above.

Favorable examples of the polyolefin resins include, but are not particularly limited to, polyethylenes (in particular, linear low-density polyethylenes, low-density polyethylenes), polypropylenes, polybutenes, poly(4-methyl-1-pentene), and ethylene-α-olefin copolymers (copolymers of ethylene with an α-olefin having 3 to 10 carbon atoms) and, in particular, a mixed resin containing at least two ethylenic polymers selected from linear low-density polyethylenes, low-density polyethylenes, and ethylene-α-olefin copolymers can be used favorably. The mixed resin of ethylenic polymers preferably contains at least one linear low-density polyethylene and additionally a low-density polyethylene and/or an ethylene-α-olefin copolymer.

The comonomer component used with ethylene in the linear low-density polyethylene can be chosen arbitrarily, but in particular, 1-hexene and 1-octene are preferable. Favorable examples of the ethylene-α-olefin copolymers include ethylene-propylene copolymers, ethylene-(1-butene) copolymers and the like.

The release liner A can be formed by a known or common method. In addition, the surface of the release liner A having an arithmetic mean roughness (Ra) of 0.6 μm or more and less than 20 μm can be formed by a known or common surface-roughening method. The surface-roughening method may be, for example, a surface-roughening method of surface-roughening the release layer by forming a release layer and then surface-roughening the release layer surface by pressing, for example, a molding roll (embossing roll) having an engraved irregular pattern onto the release layer.

The release liner A is preferably a polyolefin-based release liner carrying an irregular pattern formed on the surface of the release layer composed of a polyolefin, and typical favorable examples thereof include the release liners described in Japanese Unexamined Patent Publication No. 2005-350650 and the like. The irregular pattern is preferably an irregular pattern in which the protrusions and dents in various different shapes are distributed at random positions.

### [Release Liner B]

The release liner B for use in the thermosetting adhesive tape or sheet of the present invention (double separator-type thermosetting adhesive tape or sheet) may be a known or common release liner. The release liner B is preferably a non-silicone-based release liner, for example for prevention of contamination with silicone components, although it is not particularly limited thereto. Specifically, for example, release liners having a release layer, low-adhesiveness release liners composed of a fluorochemical polymer, low-adhesiveness release liners of a non-polar polymer and the like can be used. Examples of the release liners having a release layer include plastic films and papers surface-treated with a release-coating agent such as a long-chain alkyl-, fluorine- or molybdenum sulfide-based release-coating agent, and the like. Examples of the fluorochemical polymers include polytetrafluoroethylene, polychlorotrifluoroethylene, polyvinyl fluoride, polyvinylidene fluoride, tetrafluoroethylene-hexafluoropropylene copolymers, chlorofluoroethylene-vinylidene fluoride copolymers and the like. Examples of the non-polar polymers include olefinic resins (e.g., polyethylene, polypropylene) and the like.

The arithmetic mean roughness (Ra) of the release face of release liner B is not particularly limited, but preferably, for example, 0.1 μm or more and less than 0.6 μm, more preferably 0.1 to 0.5 μm. When the arithmetic mean roughness is 0.1 μm or more, it is possible to assure adhesion of the release liner to the thermosetting adhesive layer to some extent and thus to improve the protection efficiency. Alternatively, when the arithmetic mean roughness is less than 0.6 μm, the thermosetting adhesive layer can be bonded temporarily to an adherend.

The release liner B can be formed by a known or common method. Typical favorable examples of the release liners B include the polyolefin-based release liners described in Japanese Patent No. 3901490 and the like.

### [Adhesive Body]

The adhesive body in the thermosetting adhesive tape or sheet of the present invention may be an adhesive body having a base material or an adhesive body having no base material (base-less adhesive body). The adhesive body having a base material is, for example, an adhesive body having a thermosetting adhesive layer on at least one surface side of the base material. The base material-less adhesive body is, for example, an adhesive body having only a thermosetting adhesive layer. In particular, a base-less adhesive body is preferable from the viewpoint of reduction of the voids generated by the air bubbles remaining between the layers of the laminate, and more preferable is an adhesive body having only a thermosetting adhesive layer (double-faced adhesive body).

### (Thermosetting Adhesive Layer)

The thermosetting adhesive layer in the adhesive body is a thermosetting adhesive layer that cures when heated and shows superior adhesive power. The thermosetting adhesive layer is not particularly limited, but preferably a thermosetting adhesive layer formed with a thermosetting adhesive composition containing an acrylic polymer (X) and a thermosetting resin (Y) as essential components, from the viewpoint of conversion thereof into the shape of tape or sheet.

The content of the acrylic polymer (X) is not particularly limited, but, for example, preferably 70 to 99 wt %, more preferably 80 to 99 wt %, and still more preferably 85 to 99 wt %, with respect to the solid content (100 wt %) of the thermosetting adhesive composition.

The acrylic polymer (X) is a polymer configured (formed) to contain an acrylic monomer as the essential monomer component. In particular, the acrylic polymer (X) is preferably an acrylic polymer configured to have an alkyl (meth)acrylate containing a straight-chain or branched-chain alkyl group having 2 to 14 carbon atoms (hereinafter, referred to as “02.14 alkyl (meth)acrylate”) (a) as the essential monomer component, more preferably an acrylic polymer configured with monomer components including a C₂₋₁₄ alkyl (meth)acrylate (a), a cyano group-containing monomer (b), and a carboxyl group-containing monomer (c). Particularly preferable is an acrylic polymer configured with monomer components containing a C₂₋₁₄ alkyl (meth)acrylate (a) at a rate of 39.5 to 75 wt %, a cyano group-containing monomer (b) at a rate of 24 to 60 wt %, and a carboxyl group-containing monomer (c) at a rate of 0.5 to 10 wt %, with respect to the total amount (100 wt %) of the monomer components constituting the acrylic polymer (X). Monomer components other than those above may be used as the monomer components constituting the acrylic polymer (X). The term “(meth)acryl” means “acryl” and/or “methacryl”, and the same applies to similar terms.

When an acrylic polymer configured with the monomer components above is used as the acrylic polymer (X), the adhesive face a in the thermosetting adhesive tape or sheet of the present invention shows resistance to deposition of foreign matter and additionally, adhesiveness to a degree temporarily bonded to the adherend when pushed under pressure (limited adhesiveness). Even when the adhesive body in the thermosetting adhesive tape or sheet of the present invention is a base-less adhesive body having only a single thermosetting adhesive layer, it is possible to use one adhesive face as an adhesive face (adhesive face a) resistant to deposition of foreign matter and bondable temporarily, and the other adhesive face (adhesive face b) as an adhesive face easily bondable temporarily to the adherend and thus, such a thermosetting adhesive tape or sheet is compatible with a wider range of tape or sheet design.

In particular, the acrylic polymer (X) is preferably an acrylic polymer showing rubber elasticity (elastomer property).

The C₂₋₁₄ alkyl (meth)acrylate (a) is not particularly limited, if it is an alkyl (meth)acrylate having a straight-chain or branched-chain alkyl group having 2 to 14 carbon atoms, and examples thereof include ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate and the like. In particular, alkyl (meth acrylates having an alkyl group having 4 to 12 carbon atoms are preferable, and n-butyl acrylate is particularly preferable. The C₂₋₁₄ alkyl (meth)acrylates (a) may be used alone or in combination of two or more.

The content of the C₂₋₁₄ alkyl (meth acrylate (a) is not particularly limited but, for example, preferably 39.5 to 75 wt %, more preferably 44 to 72 wt %, still more preferably 48.5 to 70 wt % and particularly more preferably 51 to 70 wt %, with respect to the total amount (100 wt %) of the monomer components constituting the acrylic polymer (X). A content of 39.5 wt % or more leads to improvement of the flexibility of the thermosetting adhesive layer. Alternatively, a content of 75 wt % or less prevents excessive of the adhesiveness of the thermosetting adhesive layer at normal temperature, which in turn leads to suppression of deposition of foreign matter.

The cyano group-containing monomer (b) is not limited, if it is a monomer having a cyano group, and examples thereof include acrylonitrile, methacrylonitrile and the like. In particular, acrylonitrile can be used preferably as the cyano group-containing monomer (b). The cyano group-containing monomers (b) can be used alone or in combination of two or more.

The content of the cyano group-containing monomer (b) is not particularly limited but, for example, preferably 24 to 60 wt %, more preferably 25 to 55 wt %, still more preferably 25 to 50 wt %, and particularly more preferably 28 to 43 wt %, with respect to the total amount (100 wt %) of the monomer components constituting the acrylic polymer (X). A content of 24 wt % or more prevents excessive increase of the adhesiveness of the thermosetting adhesive layer at normal temperature, which in turn leads to suppression of deposition of foreign matter. It also leads to improvement in heat resistance after wet-heat treatment. Alternatively, a content of 60 wt % or less leads to improvement of the flexibility of the thermosetting adhesive layer. The “heat resistance after wet heat treatment” is a property of a thermosetting adhesive tape or sheet showing resistance to local separation and swelling when the thermosetting adhesive tape or sheet is bonded to an adherend, stored under high-temperature and high-humidity condition and then heated at high temperature.

The carboxyl group-containing monomer (c) is not particularly limited, if it is a monomer having a carboxyl group, and examples thereof include (meth)acrylic acid, itaconic acid, maleic acid, fumaric acid, crotonic acid and the like. The anhydrides of these carboxyl group-containing monomers (e.g., acid anhydride group-containing monomers such as maleic anhydride and itaconic anhydride) can also be used as the carboxyl group-containing monomers (c). In particular, acrylic acid, methacrylic acid, and itaconic acid are used preferably as the carboxyl group-containing monomers (c). The carboxyl group-containing monomers (c) may be used alone or in combination of two or more.

The content of the carboxyl group-containing monomer (c) is not particularly limited but, for example, preferably 0.5 to 10 wt %, more preferably 1 to 9 wt %, still more preferably 1.5 to 8 wt % and particularly more preferably 1.5 to 6 wt %, with respect to the total amount (100 wt %) of the monomer components constituting the acrylic polymer (X). A content of 0.5 wt % or more prevents excessive increase of adhesiveness of the thermosetting adhesive layer at normal temperature, which in turn lead to suppression of deposition of foreign matter. It also leads to improvement in heat resistance after wet heat treatment and also in adhesiveness after thermal curing. Alternatively, a content of 10 wt % or less leads to improvement of the flexibility of the thermosetting adhesive layer.

In addition to the C₂₋₁₄ alkyl (meth)acrylates (a), the cyano group-containing monomers (b), and the carboxyl group-containing monomers (c) described above, other monomer components (copolymerizable monomers) may be used as the monomer components constituting the acrylic polymer (X). Examples of the copolymerizable monomers include methyl (methacrylate; C₁₅₋₂₀ alkyl (meth)acrylates such as pentadecyl (meth)acrylate, hexadecyl (meth)acrylate, heptadecyl (meth)acrylate, octadecyl (methacrylate, nonadecyl (methacrylate, and eicosyl (methacrylate; non-aromatic ring-containing (meth)acrylates such as cycloalkyl (meth)acrylates [cyclohexyl (meth)acrylate, etc.] and isobornyl (meth)acrylate; aromatic ring-containing (meth)acrylates such as aryl (meth)acrylates [phenyl (meth)acrylate, etc.], aryloxyalkyl (meth)acrylates [phenoxyethyl (meth)acrylate, etc.], and arylalkyl (meth)acrylates [benzyl (meth)acrylate]; epoxy group-containing acrylic monomers such as glycidyl (meth)acrylate and methylglycidyl (meth)acrylate; vinyl ester monomers such as vinyl acetate and vinyl propionate; styrene-based monomers such as styrene and α-methylstyrene; hydroxyl group-containing monomers such as hydroxyethyl (meth)acrylate, hydroxypropyl (moth) acrylate, and hydroxybutyl (meth)acrylate; alkoxyalkyl (meth)acrylate-based monomers such as methoxyethyl (meth)acrylate and ethoxyethyl (meth)acrylate; amino alkyl (meth) acrylate-based monomers such as aminoethyl (meth) acrylate, N,N-dimethylaminoethyl (meth)acrylate, and t-butylaminoethyl (moth) acrylate; (N-substituted) amide-based monomers such as (meth) acrylamide, N,N-dimethyl(meth)acrylamide, N-butyl(meth)acrylamide, and N-hydroxy (meth)acrylamide; olefinic monomers such as ethylene, propylene, isoprene, and butadiene; vinyl ether-based monomers such as methyl vinyl ether and the like.

Other copolymerizable monomers that can be used include polyfunctional monomers such as hexanediol di(meth)acrylate, (poly)ethylene glycol di(meth)acrylate, (poly)propylene glycol di(meth)acrylate, neopentylglycol di(meth)acrylate, pentaerythritol di(meth)acrylate, glycerol di(meth)acrylate, trimethylolpropane tri(meth)acrylate, pentaerythritol tri(meth)acrylate, dipentaerythritol hexa(meth)acrylate, divinylbenzene, butyl di(meth)acrylate, and hexyl di(meth)acrylate.

The acrylic polymer (X) can be prepared by a known or common polymerization method (e.g., solution polymerization method, emulsion polymerization method, suspension polymerization method, bulk polymerization method, UV irradiation polymerization method).

In polymerization of the acrylic polymer (X), a known or common polymerization initiator, an emulsifier, a chain-transfer agent or the like may be used. Typical examples of the polymerization initiators include am-based polymerization initiators such as 2,2′-azobisisobutylonitrile, 2,2′-azobis (4-methoxy-2,4-dimethylvaleronitrile), 2,2′-azobis (2,4-dimethylvaleronitrile), 2,2′-azobis (2-methylbutylonitrile), 1,1′-azobis(cyclohexane 1-carbonitrile), 2,2′-azobis (2,4,4-trimethylpentane), dimethyl-2,2′-azobis(2-methylpropionate), and 2,2′-azobis{2-[1-(2-hydroxyethyl)-2-imidazolin-2-yl]propane}dihydrochloride; peroxide-based polymerization initiators such as benzoyl peroxide, t-butyl hydroperoxide, di-t-butyl peroxide, t-butyl peroxybenzoate, dicumyl peroxide, 1,1-bis (t-butylperoxy)-3,3,5-trimethylcyclohexane, and 1,1-bis(t-butylperoxy)cyclododecane, and the like. These polymerization initiators may be used alone or in combination of two or more. The amount of the polymerization initiator used can be selected properly in the range normally used.

Examples of the chain-transfer agents include dodecanethiol, 2-mercaptoethanol, laurylmercaptan, glycidylmercaptan, mercaptoacetic acid, 2-ethylhexyl mercaptoacetate, 2,3-dimercapto-1-propanol, α-methylstyrene dimer and the like. Examples of the emulsifiers include anionic emulsifiers such as sodium laurylsulfate, ammonium laurylsulfate, sodium dodecylbenzenesulfonate, sodium polyoxyethylene alkyl ether sulfates, ammonium polyoxyethylene alkylphenyl ether sulfates and sodium polyoxyethylene alkylphenyl ether sulfates; nonionic emulsifiers such as polyoxyethylene alkyl ethers and polyoxyethylene alkylphenyl ethers, and the like.

In solution polymerization, various common solvents can be used. Examples of such solvents include organic solvents including esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; ketones such as methylethylketone and methylisobutylketone; and alcohols such as methanol and butanol. The solvents can be used alone or in combination of two or more.

The weight-average molecular weight of the acrylic polymer (X) is not particularly limited but, for example, preferably 200,000 to 1600,000, more preferably 300,000 to 1400,000, and still more preferably 300,000 to 700,000. A weight-average molecular weight of 200,000 or more leads to improvement in heat resistance after wet heat treatment. Alternatively, a weight-average molecular weight of 1600,000 or less leads to improved adhesiveness to the adherend when it is bonded by heating. The weight-average molecular weight of the acrylic polymer (X) can be controlled for example by adjustment of the kinds and amounts of the polymerization initiator and the chain-transfer agent, the temperature and the period of polymerization, monomer concentration or the speed of monomer dropwise addition.

The weight-average molecular weight can be determined by a gel-permeation chromatographic (GPC) method. Specifically, for example, it can be determined by the following method under the following condition.

(Method of Preparing Samples)

An acrylic polymer (X) was dissolved in the following solvent, to give a 0.1% DMF solution. After storage for one day, the solution was filtered through a 0.45 μm membrane filter and the filtrate was subjected to GPC measurement.

(Measuring Condition)

GPC Apparatus: HLC-8120GPC (manufactured by TOSOH CORPORATION)

Column: TSK gel superAWM-H, TSK gel superAW4000 and TSK gel superAW2500 (manufactured by TOSOH CORPORATION))

Column size: 6 mmφ×15 cm (each column), total length: 45 cm

Column temperature: 40° C.

Eluant 10 mM-LiBr, 10 mM-phosphoric acid/DMF

Flow rate: 0.4 mL/min

Inlet pressure: 4.6 MPa

Injection amount: 20 μL

Detector: differential refractometer

Standard sample: polyethyleneoxide

Data-processing apparatus: GPC-8020 (manufactured by TOSOH CORPORATION)

The thermosetting resin (Y) in the thermosetting adhesive composition constituting the thermosetting adhesive layer is not particularly limited, if it is a resin that cures by crosslinking under heat, and examples thereof include phenol resins, epoxy resins and the like. In particular, phenol resins are preferable from the viewpoint of storage stability. In other words, the thermosetting adhesive layer is preferably a thermosetting adhesive layer formed with a thermosetting adhesive composition containing an acrylic polymer (X) and a phenol resin as essential components.

The phenol resin is not particularly limited and can be used, as selected properly from resol phenol resins, novolak phenol resins, various modified phenol resins etherified phenol resins, alkyl-modified phenol resins) and the like. The phenol resins can be used alone or in combination of two or more.

In particular, the phenol resin for use is preferably an etherified phenol resin in which part or all of the methylol groups are etherified with alkyl groups (alkyl-etherified phenol resin). When an etherified phenol resin is used as the thermosetting resin (Y), the thermosetting adhesive tape or sheet (thermosetting adhesive layer) has improved storage stability at room temperature and additionally, improved post-curing adhesiveness by rapid progress of the curing reaction and superior heat resistance after wet heat treatment.

The etherified phenol resin is not particularly limited and can be used, as it is selected properly form novolak etherified phenol resins, resol etherified phenol resins, novolak etherified cresol resins, resol etherified cresol resins and the like. In particular, use of a resol etherified cresol resin is preferable.

The alkyl group in the alkyl ether structure of the etherified phenol resin is not particularly limited and can be selected, for example, from methyl group, ethyl group, propyl group, isopropyl group, n-butyl group, isobutyl group, s-butyl group, t-butyl group, pentyl group, isopentyl group, hexyl group, heptyl group, octyl group, 2-ethylhexyl group, isooctyl group, nonyl group, isononyl group, decyl group, isodecyl group, undecyl group, dodecyl group, tridecyl group, tetradecyl group, pentadecyl group, hexadecyl group, heptadecyl group, octadecyl group, nonadecyl group, eicosyl group and the like. In particular, n-butyl group is preferable from the viewpoint of production. Thus, the etherified phenol resin is preferably a butyl-etherified phenol resin (phenol resin of which the methylol groups are butyl-etherified), in particular, a butyl-etherified cresol resin (cresol resin of which the methylol groups are butyl-etherified) from the viewpoint of reactivity.

The content of the etherified methylol groups (i.e., alkyl ether groups) in the etherified phenol resin is preferably 50 mol % or more, with respect to the total amount (100 mol %) of the etherified methylol groups and the non-etherified methylol groups. An etherified methylol group content of less than 50 mol % may lead to accelerated reaction of the etherified phenol resin at room temperature and also to deterioration in reactivity during thermal curing. The content of the etherified methylol groups can be determined, for example, from ¹H-NMR spectrum.

The etherified phenol resin for use may be a commercially available etherified phenol resin. Specifically, for example, “SUMILITE RESIN PR-55317” (trade name, manufactured by SUMITOMO BAKELITE CO., LTD. CO., LTD., a butyl-etherified cresol resin, etherified methylol group content: 90 mol %) may be used.

The content of the thermosetting resin (Y) (in particular, etherified phenol resin) in the thermosetting adhesive composition is not particularly limited but, for example, preferably 1 to 40 parts by weight, more preferably 1 to 20 parts by weight, and still more preferably 1 to 15 parts by weight, with respect to 100 parts by weight of the acrylic polymer (X). A content of 1 part by weight or more leads to improvement in adhesiveness after thermal curing. Alternatively, a content of 40 parts by weight or less leads to prevention of protrusion of the adhesive during heat adhesion.

In addition to the acrylic polymer (X) and the thermosetting resin (Y) above, the thermosetting adhesive composition may contain, as needed, known additives such as aging inhibitors, filler, colorants (e.g., pigments and dyes), ultraviolet absorbents, antioxidants, crosslinking agents, tackifiers, plasticizers, softeners, surfactants, antistatic agents in the range that does not impair the advantageous effect of the present invention.

The thermosetting adhesive composition can be prepared, for example, by mixing an acrylic polymer (X), a thermosetting resin (Y), and additionally, as needed, various additives (e.g., aging inhibitors, filler, pigments).

The acrylic polymer (X) or the thermosetting resin (Y) can be used in the state of solution, as it is dissolved in a solvent, or in the state of dispersion, as it is dispersed in a dispersion medium. The solvent or the dispersion medium is not particularly limited and can be selected properly, for example, from the solvents used in production of the acrylic polymer (X) by solution polymerization.

The thickness of the thermosetting adhesive layer in the thermosetting adhesive tape or sheet of the present invention is not particularly limited but, for example, preferably 5 to 100 μm, more preferably 10 to 50 μm. A thickness of 5 μm or more leads to sufficient adhesiveness. Alternatively, a thickness of 100 μm or less lead to prevention of protrusion of the thermosetting adhesive layer during high-temperature pressurization. When the thermosetting adhesive layer has an irregular surface, “the thickness of the thermosetting adhesive layer” is a thickness, as determined based on the protuberances.

The storage elastic modulus of the thermosetting adhesive layer at 23° C., as determined by dynamic viscoelastic measurement (hereinafter, referred to as “storage elastic modulus (23° C.)” or “G′ (23° C.”) is not particularly limited but preferably, for example, 1.0×10⁴ to 1.0×10⁸ Pa, more preferably 1.0×10⁵ to 1.0×10⁸ Pa, and still more preferably 1.0×10⁸ to 1.0×10⁷ Pa. A storage elastic modulus (23° C.) of 1.0×10⁴ Pa or more makes it easier to transfer the irregular pattern of the release face of release liner A onto the adhesive face a, effectively surface-roughening the adhesive face a. Alternatively, a storage elastic modulus (23° C.) of 1.0×10⁸ Pa or less makes the thermosetting adhesive layer have adhesiveness sufficient for temporary adhesion to the adherend, when pressed thereto under pressure. The storage elastic modulus (23° C.) is determined by dynamic viscoelastic measurement. Specifically, it can be determined, for example, by laminating multiple thermosetting adhesive layers to a thickness of approximately 1.5 mm and measuring the storage elastic modulus of the laminate by using “Advanced Rheometric Expansion System (ARES)” manufactured by Rheometric Scientific Inc., under the condition of, a frequency of 1 Hz and a heating rate of 5° C./minute in a temperature range of −70 to 200° C. in the shear mode.

The storage elastic modulus (23° C.) can be controlled, for example, by adjustment of the monomer composition of the acrylic polymer (X).

### (Base Material)

When the adhesive body of the thermosetting adhesive tape or sheet of the present invention has a base material, the base material is not particularly limited, and examples of the base materials favorably used are suitable leaf-shaped materials including paper-based base materials such as paper; fiber-based base materials such as woven, nonwoven fabrics, and nets; metal-based base materials such as metal foils and metal plates; plastic-based base materials such as films and sheets of various resins (olefinic resins, polyester resins, polyvinyl chloride resins, vinyl acetate resins, amide resins, polyimide resins, polyether ether ketone (PEEK), polyphenylene sulfide (PPS), etc.); rubber-based base material such as rubber sheets; foams such as foam sheets; the laminated films thereof (in particular, laminated films of a plastic-based base material and another base material and also of plastic films (or sheets), etc.) and the like. The release liner, which is removed before use, is not included in the “base material”.

The thickness of the base material is not particularly limited, but preferably, for example 10 to 500 μm, more preferably 12 to 200 μm, and more preferably 15 to 100 μm. The base material may be in the configuration of single layer or multiple layers. The base material may be subjected, as needed, to various treatments such as rear face treatment, antistatic treatment, and undercoating treatment.

The adhesive body in the thermosetting adhesive tape or sheet of the present invention may have layers other than the thermosetting adhesive layer and the base material (e.g., intermediate layer, undercoat layer, etc.), in the range that does not impair the advantageous effects of the invention.

The arithmetic mean roughness (Ra) of the adhesive face a of the adhesive body in the thermosetting adhesive tape or sheet of the present invention is not particularly limited but preferably, for example, 0.7 μm or more and less than 20 μm, more preferably 0.8 μm or more and less than 18 μm, and still more preferably 1.0 μm or more and less than 15 μm. An arithmetic mean roughness of 0.7 μm or more leads to suppression of deposition of foreign matter to the adhesive face a. Alternatively, an arithmetic mean roughness of less than 20 μm leads to prevent excessive increase of the release force of the release liner A to the thermosetting adhesive layer and thus leads to improvement in processability. It also leads to increase in air tightness to the adherend and improvement in adhesiveness.

The arithmetic mean roughness (Ra) of the adhesive face a can be controlled, for example, by adjustment of the arithmetic mean roughness of the release face of release liner A and the storage elastic modulus (23° C.) of the thermosetting adhesive layer.

The arithmetic mean roughness (Ra) of the adhesive face b of the adhesive body in the thermosetting adhesive tape or sheet of the present invention is not particularly limited, but preferably, for example, less than 0.7 μm (e.g., 0.1 μm or more and less than 0.7 μm), more preferably 0.15 μm or more and less than 0.7 μm. When the thermosetting adhesive layer has adhesiveness, an arithmetic mean roughness of less than 0.7 μm leads to easier temporary adhesion of the adhesive face b to the adherend and thus to improvement in processability.

The 180° peel adhesion to polyimide of the adhesive face a of the adhesive body in the thermosetting adhesive tape or sheet of the present invention, as determined at a tensile speed 100 mm/minute, is not particularly limited, but preferably, for example, 1N12 cm or less (for example, 0 to 1N/2 cm), more preferably 0 to 0.9 N/2 cm, and still more preferably 0 to 0.8 N/2 cm. A 180° peel adhesion of 1N/2 cm or less leads to suppression of deposition of foreign matter to the adhesive face a.

Particularly, in the range above, a 180° peel adhesion of 0.01N/2 cm or more suppresses deposition of foreign matter to the adhesive face a and makes it easier to bond the adhesive face a to the adherend to a degree that it is not removed when pressed under pressure, thus leading to improvement in processability for example during affixing. The 180° peel adhesion can be determined, in accordance with JIS Z0237 (2000), by the 180° peel test of the thermosetting adhesive tape or sheet (adhesive body) to polyimide film by using a tensile tester (tensile speed: 100 mm/minute) under an atmosphere at 23° C. and 50% RH.

The 180° peel adhesion can be controlled, for example, by adjustment of the monomer composition of the acrylic polymer (X) and the arithmetic mean roughness (Ra) of the adhesive face a.

The 180° peel adhesion to polyimide of the adhesive face b of the adhesive body in the thermosetting adhesive tape or sheet of the present invention, as determined at a tensile speed of 100 mm/minute, is not particularly limited but preferably, for example, 1.0 to 10 N/2 cm, more preferably 1.2 to 8 N/2 cm, A 180° peel adhesion of 1.0 N/2 cm or more permits easier temporary adhesion of the adhesive face b to an adherend and thus leads to improvement in processability. Alternatively, a 180° peel adhesion of 10 N/2 cm or less permits repeated adhesion, if the tape or sheet is bonded temporarily to an incorrect position.

### [Properties of Thermosetting Adhesive Tape or Sheet]

The release force (180° peeling) of the release face of release liner A to the thermosetting adhesive layer in the thermosetting adhesive tape or sheet of the present invention, as determined at a tensile speed of 300 mm/minute, is not particularly limited but preferably, for example, 0.3 N/5 cm or less (e.g., 0.01 to 0.3 N/5 cm), more preferably 0.01 to 0.25 N/5 cm, and still more preferably 0.01 to 0.2 N/5 cm. A release force of 0.3 N/5 cm or less makes it easier to separate the release liner A from the thermosetting adhesive layer, thus leading to improvement in affixing processability. Alternatively, a release force of 0.01N/5 cm or more assures adhesion between the release liner A and the thermosetting adhesive layer to some extent and leads to improvement in protection efficiency. The “release force” means a 180° peel strength (180° peel adhesion) of a release liner to the thermosetting adhesive layer, as determined by the 180° peel test in accordance with JIS 20237 (2000).

The release force can be controlled, for example, by adjustment of the monomer composition of the acrylic polymer (X), the arithmetic mean roughness (Ra) of the adhesive face a, and the arithmetic mean roughness (Ra) of the release face of the release liner A.

When the thermosetting adhesive tape or sheet of the present invention is a single separator-type, the release face of release liner A, which normally demands greater force (release force) for separation, becomes a “hardly separable face”, while the rear non-release face, which can be separated from the adhesive face with smaller force, becomes the “easily separable face”: Alternatively, when the thermosetting adhesive tape or sheet of the present invention is a double separator-type, the release liner A is normally used as the “hardly separable face”-sided release liner and the release liner B as the “easily separable face”-sided release liner.

The thermosetting adhesive tape or sheet of the present invention can be produced by a known or common production method for adhesive tapes or sheets. Specifically when the adhesive body in thermosetting adhesive tape or sheet does not have a base material, it can be produced by coating the thermosetting adhesive composition described above (e.g., thermosetting adhesive composition in the solution state) on a release liner to a particular thickness after drying and drying the resulting coated product.

In particular, the production method for the thermosetting adhesive tape or sheet of the present invention is preferably a method of coating a thermosetting adhesive composition on the release face of a release liner A and drying the resulting coated release liner A. It is possible by such a method to transfer the irregular pattern on the release face of release liner A onto the thermosetting adhesive layer surface and to control the arithmetic mean roughness of the thermosetting adhesive layer surface easily in the range above. It is thus possible by the production method to provide efficiently a thermosetting adhesive tape or sheet that is resistant to adhesion of foreign matter to the surface of the thermosetting adhesive layer.

When a pressure-sensitive adhesive layer is formed by direct coating of a pressure-sensitive adhesive composition on the surface of a release liner with an irregular pattern formed thereon in a common pressure-sensitive adhesive tape or sheet, the pressure-sensitive adhesive layer, which is soft, penetrates deep into the irregular region of the release liner, making it difficult to separate the release liner from the pressure-sensitive adhesive layer and thus leading to decrease in processability. In contrast, the thermosetting adhesive tape or sheet of the present invention, even if it is prepared by the method above, is superior in processability because the release force between the release liner A and the thermosetting adhesive layer is not excessively high. It is probably the results obtained because, compared to the pressure-sensitive adhesive layer of a common pressure-sensitive adhesive tape or sheet, the thermosetting adhesive layer of the thermosetting adhesive tape or sheet demands more heat resistance and is thus less flexible.

Alternatively, when the thermosetting adhesive tape or sheet of the present invention is prepared by a method of forming a thermosetting adhesive layer by coating and drying a thermosetting adhesive composition on a suitable substrate or release liner and forming a release liner A on the surface of the thermosetting adhesive layer in such a manner that the release face of release liner A is in contact with the thermosetting adhesive layer, the irregular pattern on the release face is transferred less easily onto the surface of the thermosetting adhesive layer. It is thus difficult by such a production method to provide efficiently a thermosetting adhesive tape or sheet that is resistant to deposition of foreign matter to the surface of the thermosetting adhesive layer.

In application (coating) of the thermosetting adhesive composition described above, any common coater (e.g., gravure roll coater, reverse roll coater, kiss roll coater, dip roll coater, bar coater, knife coater, spray roll coater) may be used.

The thermosetting adhesive tape or sheet of the present invention, which has a release liner A, is resistant to deposition of foreign matter to the adhesive face a. It is probably the results obtained because the thermosetting adhesive layer itself is not highly tacky, and the adhesive face in contact with the release face of release liner A (adhesive face a), which is surface-roughened, has a reduced contact area to the foreign matter.

Generally, for restriction of deposition of foreign matter to the thermosetting adhesive layer to the thermosetting adhesive tape or sheet, a method of reducing the adhesiveness of the thermosetting adhesive layer by modification of the composition (components) of the thermosetting adhesive layer is considered. However, if the adhesiveness (in particular, tackiness) is reduced by modification of the composition of the thermosetting adhesive layer, deposition of foreign matter to the thermosetting adhesive layer may be inhibited, but it may be difficult to obtain well-balanced physical properties of the thermosetting adhesive tape or sheet, because of deterioration in adhesiveness after heating, for example. In addition, it is often difficult to modify the composition of the thermosetting adhesive layer, for example because the monomer component that contributes to reduction of adhesiveness in the components constituting the acrylic polymer (e.g., cyano group-containing monomer (b) described above) is less copolymerizable. The thermosetting adhesive tape or sheet of the present invention, which is resistant to deposition of foreign matter to the thermosetting adhesive layer surface, is particularly useful, because there is no need for modification of the thermosetting adhesive layer (e.g., modification in composition).

Release liners with a surface-irregular pattern have been used in adhesive tapes or sheets (pressure-sensitive adhesive tapes or sheets). However, use of such a release liner is aimed mainly at control of the release force and, in the case of such an adhesive tape or sheet, deposition of foreign matter is not suppressed, even if an irregular pattern formed on the adhesive layer surface by using the release liner, because the adhesive layer has low elastic modulus and high adhesiveness. Thus, there has been no attention paid to the relationship between the surface roughness of the release liner in contact with the adhesive face of tape or sheet and the easiness of deposition of foreign matter to the adhesive face.

The thermosetting adhesive tape or sheet of the present invention is an adhesive tape or sheet for a flexible printed circuit board. Specifically, the thermosetting adhesive tape or sheet of the present invention is used during adhesion of a flexible printed circuit board (FPC), specifically in the application of producing FPCs by adhering and laminating a conductive metal foil such as copper or aluminum foil to a heat-resistant base material (e.g., polyimide base material, polyamide base material), in the application of adhering a FPC to a reinforcing plate (e.g., aluminum plate, stainless steel plate, polyimide plate), and in other applications.

In the applications above, the thermosetting adhesive tape or sheet of the present invention may be used, as the thermosetting adhesive layer is exposed, for example, in the steps of punching the thermosetting adhesive tape or sheet, adhering a FPC to a reinforcing plate such as aluminum plate, stainless steel plate or polyimide plate, and punching a thermosetting adhesive tape or sheet having a reinforcing plate. Even in such a case, it is possible by using the thermosetting adhesive tape or sheet of the present invention to raise processability, because deposition of foreign matter such as dust and dirt to the thermosetting adhesive layer surface is suppressed.

### EXAMPLES

Hereinafter, the present invention will be described more in detail with reference to Examples, but it should be understood that the present invention is not restricted by these Examples.

### Preparation Example of Release Liner 1

7 parts by weight of an accelerator (trade name “CAT HY-91”, manufactured by Toyo-Morton, Ltd.) was blended with 100 parts by weight of an ester urethane-based anchor-coating agent (trade name “AD-527”, manufactured by Toyo-Morton, Ltd.), and then, the mixture was diluted with ethyl acetate to a solid content concentration of 5 wt %, to give an anchor-coating agent (undercoating agent) solution. The anchor-coating agent solution was coated on a polyethylene terephthalate film (“LUMIRROR S-105-50”, manufactured by Toray Industries Inc., thickness: 50 μm) to a thickness of about 1 μm (coating thickness after drying: 0.1 μm) with a roll coater and dried at 80° C., to form an anchor coat layer. On the anchor coat layer, low-density polyethylene (trade name “L-1850A”, manufactured by Asahi Kasei Corporation) was extrusion-laminated by tandem method at a die-bottom temperature of 325° C. to a thickness of 10 μm, to form an undercoat layer. Subsequently, a resin composition (constituent component for the release layer) containing 100 parts by weight of a mixed resin containing a linear low-density polyethylene as the principal component (trade name “MORETEC 0628D”, manufactured by Prime Polymer Co., Ltd.) and 150 parts by weight of an ethylene-propylene copolymer (trade name “TAFMER P0180”, manufactured by Mitsui Chemicals, Inc.) was extrusion-laminated on the undercoat layer at a die-bottom temperature of 273° C. to a thickness of 10 μm, to form a release layer; and additionally, the surface of the release layer was roughened by using an embossed cooling mat roll (pressurization pressure: 0.5 MPa) as a chill roll, forming a release layer having a surface with an irregular pattern (surface irregular release layer), to give a release liner (release liner a, total thickness: approximately 70 μm).

The irregular pattern formed on the surface-irregular release layer is a pattern in which the irregularities different in shape are distributed unevenly. The arithmetic mean roughness (Ra) of the surface of the surface-irregular release layer was 1.0

### Preparation Example of Release Liner 2

A release liner having a surface-irregular release layer (release liner b, total thickness: approximately 70 μm) was prepared in a manner similar to the “Preparation Example of release liner 1”, except that the pressurization pressure of the embossed cooling mat roll was changed to 1 MPa.

The irregular pattern of the surface-irregular release layer may be a pattern in which irregularities different in shape are distributed at uneven positions. The arithmetic mean roughness (Ra) of the surface of the surface-irregular release layer was 1.3 μm.

### Preparation Example of Release Liner 3

A liner having a medium-density polyethylene (MDPE) laminated on a paper base material (trade name “LL-50N”, manufactured by LINTEC Corporation) was coated on both faces with silicone, forming a release layer, to give a release liner (release liner a, total thickness: approximately 110 μm).

The arithmetic mean roughnesses (Ra) of the surfaces (both surfaces) of the release layer of the release liner c were both 0.49 μm.

### Preparation Example of Release Liner 4

A resin composition (component constituting the release layer) containing 100 parts by weight of a mixed resin containing a linear low-density polyethylene (trade name “MORETEC 0628D”, manufactured by Prime Polymer Co., Ltd.) as the principal component and 150 parts by weight of an ethylene-propylene copolymer (trade name “TAFMER P0180”, manufactured by Mitsui Chemicals, Inc.) was extrusion-laminated onto a polyethylene terephthalate film (“LUMIRROR S-10”, manufactured by Toray Industries Inc., thickness: 50 μm) at a die-bottom temperature of 273° C. to a thickness of 10 μm, forming a release layer, to give a release liner (release liner d, total thickness: approximately 60 μm).

The arithmetic mean roughness (Ra) of the surface of the release layer was 0.23 μm.

### Example 1

In a reactor equipped with a condenser tube, a nitrogen-supplying tube, a thermometer, and a stirrer, placed were 0.279 part by weight of 2,2′-azobis{2-[1-(2-hydroxyethyl)-2-imidazolin-2-yl]propane} dihydrochloride (trade name: “VA-060”, manufactured by Wako Pure Chemical Industries, Ltd.) (initiator) and 100 parts by weight of ion-exchange water, and the mixture was stirred for 1 hour, while nitrogen gas was introduced. The mixture was kept at 60° C., and an emulsion (emulsion of monomer raw materials) prepared by adding 70 parts by weight of butyl acrylate (n-butyl acrylate) (BA), 26 parts by weight of acrylonitrile (AN), 4 parts by weight of acrylic acid (AA), 0.04 part by weight of dodecanethiol (chain-transfer agent), and 2 parts by weight of sodium polyoxyethylene lauryl ether sulfate (emulsifier) to 41 parts by weight of ion-exchange water was added dropwise thereto gradually over 3 hours, for progress of emulsion polymerization reaction. After the dropwise addition of the monomer raw materials, the emulsion was aged additionally for 3 hours at the same temperature. The aqueous dispersion (emulsion) of the acrylic polymer thus obtained by polymerization was dried, to give an acrylic polymer (X1) (weight-average molecular weight: 410,000).

A methanol solution containing 10 parts by weight (as nonvolatile matter) of “SUMILITE RESIN PR-55317” (trade name, manufactured by SUMITOMO BAKELITE CO., LTD.) as the etherified phenol resin, as it is dissolved, was mixed and stirred with an ethyl acetate solution containing 100 parts by weight of the acrylic polymer (X1) [a copolymer obtained by copolymerization of a monomer composition: containing 70 parts by weight of butyl acrylate (BA), 26 parts by weight of acrylonitrile (AN), and 4 parts by weight of acrylic acid (AA), (weight-average molecular weight: 410,000)], as it is dissolved, to give a thermosetting adhesive composition (solution). The thermosetting adhesive composition contains 100 parts by weight of the acrylic polymer (X1) and 10 parts by weight of the etherified phenol resin.

The thermosetting adhesive composition above was coated on the surface of the release layer of release liner a to a thickness after drying of 25 μm, and the coated release liner was dried at 100° C. for 3 minutes, to give a thermosetting adhesive sheet.

### Example 2

An acrylic polymer (X2) (weight-average molecular weight: 390,000) was prepared in a manner similar to Example 1, except that 69 parts by weight of butyl acrylate (BA), 27 parts by weight of acrylonitrile (AN), and 4 parts by weight of acrylic acid (AA) were used as the monomer components.

A butanol solution containing 10 parts by weight (as nonvolatile matter) of “SUMILITE RESIN PR-55317” (trade name, manufactured by SUMITOMO BAKELITE CO., LTD.) as the etherified phenol resin, as it is dissolved, was mixed and stirred with an ethyl acetate solution containing 100 parts by weight of the acrylic polymer (X2) [a copolymer obtained by copolymerization of a monomer composition: 69 parts by weight of butyl acrylate (BA), 27 parts by weight of acrylonitrile (AN), and 4 parts by weight of acrylic acid (AA), (weight-average molecular weight: 390,000)], as it is dissolved, to give a thermosetting adhesive composition (solution). The thermosetting adhesive composition contains 100 parts by weight of the acrylic polymer (X2) and 10 parts by weight of the etherified phenol resin.

The thermosetting adhesive composition was coated on the surface of the release layer of release liner a to a thickness after drying of 25 μm, and the coated release liner was dried at 100° C. for 3 minutes, to give a thermosetting adhesive sheet.

### Example 3

An acrylic polymer (X3) (weight-average molecular weight: 390,000) was prepared in a manner similar to Example 1, except that 68 parts by weight of butyl acrylate (BA), 27 parts by weight of acrylonitrile (AN), and 5 parts by weight of acrylic acid (AA) were used as the monomer components.

A methanol solution containing 10 parts by weight (as nonvolatile matter) of “SUMILITE RESIN PR-55317” (trade name, manufactured by SUMITOMO BAKELITE CO., LTD.) as the etherified phenol resin, as it is dissolved, was mixed and stirred with an ethyl acetate solution containing 100 parts by weight of the acrylic polymer (X3) [a copolymer obtained by copolymerization by a monomer composition: 68 parts by weight of butyl acrylate (BA), 27 parts by weight of acrylonitrile (AN), and 5 parts by weight of acrylic acid (AA), (weight-average molecular weight 390,000)], as it is dissolved, to give a thermosetting adhesive composition (solution). The thermosetting adhesive composition contains 100 parts by weight of the acrylic polymer (X3) and 10 parts by weight of the etherified phenol resin.

The thermosetting adhesive composition was coated on the surface of the release layer of release liner b to a thickness after drying of 25 μm, and the coated release liner was dried at 100° C. for 3 minutes, to give a thermosetting adhesive sheet.

### Comparative Example 1

A methanol solution containing 10 parts by weight (as nonvolatile matter) of “SUMILITE RESIN PR-56317” (trade name, manufactured by SUMITOMO BAKELITE CO., LTD.) as the etherified phenol resin, as it is dissolved, was mixed and stirred with an ethyl acetate solution containing 100 parts by weight of the acrylic polymer (X1) [a copolymer obtained by copolymerization of a monomer composition: 70 parts by weight of butyl acrylate (BA), 26 parts by weight of acrylonitrile (AN), and 4 parts by weight of acrylic acid (AA), (weight-average molecular weight: 410,000)], as it is dissolved, to give a thermosetting adhesive composition (solution). The thermosetting adhesive composition contains 100 parts by weight of the acrylic polymer (X1) and 10 parts by weight of the etherified phenol resin.

The thermosetting adhesive composition was coated on the surface of the release layer of release liner c to a thickness after drying of 25 μm, and the coated release liner was dried at 100° C. for 3 minutes, to give a thermosetting adhesive sheet.

### Comparative Example 2

A butanol solution containing 10 parts by weight (as nonvolatile matter) of “SUMILITE RESIN PR-55317” (trade name, manufactured by SUMITOMO BAKELITE CO., LTD.) as the etherified phenol resin, as it is dissolved, was mixed and stirred with an ethyl acetate solution containing 100 parts by weight of the acrylic polymer (X2) [a copolymer obtained by copolymerization of a monomer composition: 69 parts by weight of butyl acrylate (BA), 27 parts by weight of acrylonitrile (AN), and 4 parts by weight of acrylic acid am (weight-average molecular weight: 390,000)], as it is dissolved, to give a thermosetting adhesive composition (solution). The thermosetting adhesive composition contains 100 parts by weight of the acrylic polymer (X2) and 10 parts by weight of the etherified phenol resin.

The thermosetting adhesive composition was coated on the surface of the release layer of release liner c to a thickness after drying of 25 μm, and the coated release liner was dried at 100° C. for 3 minutes, to give a thermosetting adhesive sheet.

### Comparative Example 3

A methanol solution containing 10 parts by weight (as nonvolatile matter) of “SUMILITE RESIN PR-55317” (trade name, manufactured by SUMITOMO BAKELITE CO., LTD.) as the etherified phenol resin, as it is dissolved, was mixed and stirred with an ethyl acetate solution containing 100 parts by weight of the acrylic polymer (X3) [a copolymer obtained by copolymerization of a monomer composition: 68 parts by weight of butyl acrylate (BA), 27 parts by weight of acrylonitrile (AN), and 5 parts by weight of acrylic acid (AA), (weight-average molecular weight: 390,000)], as it is dissolved, to give a thermosetting adhesive composition (solution). The thermosetting adhesive composition contains 100 parts by weight of the acrylic polymer (X3) and 10 parts by weight of the etherified phenol resin.

The thermosetting adhesive composition was coated on the surface of the release layer of release liner d to a thickness after drying of 25 μm, and the coated release liner was dried at 100° C. for 3 minutes, to give a thermosetting adhesive sheet.

### Comparative Example 4

In a reactor equipped with a condenser tube, a nitrogen-supplying tube, a thermometer, and a stirrer, placed were 93 parts by weight of butyl acrylate (BA), 7 parts by weight of acrylic acid (AA), 0.2 part by weight of 2,2′-azobisisobutylonitrile, and 233.8 parts by weight of toluene as polymerization solvent, and the mixture was stirred for 1 hour, while nitrogen gas was introduced. After removal of oxygen in the polymerization system as described above, the mixture was heated to 63° C. for reaction for 10 hours, to give an acrylic polymer solution having a solid content concentration of 30 wt %.

0.02 part by weight of “TETRAD-C” (trade name, manufactured by MITSUBISHI GAS CHEMICAL COMPANY, INC) as tetrafunctional epoxy-based crosslinking agent was mixed and stirred with an acrylic polymer solution containing 100 parts by weight of the acrylic polymer (X4) [a copolymer obtained by copolymerization of a monomer composition: 93 parts by weight of butyl acrylate (BA), and 7 parts by weight of acrylic acid (AA)], as it is dissolved, to give a pressure-sensitive adhesive composition solution. The pressure-sensitive adhesive composition solution contains 100 parts by weight of the acrylic polymer (X4) and 0.02 part by weight of the tetrafunctional epoxy-based crosslinking agent.

The pressure-sensitive adhesive composition was coated on the surface of the release layer of release liner a to a thickness after drying of 25 pin, and the coated release liner was dried at 100° C. for 3 minutes, to give a pressure-sensitive adhesive sheet.

### Comparative Example 5

0.02 part by weight of “TETRAD-C” (trade name, manufactured by MITSUBISHI GAS CHEMICAL COMPANY) as tetrafunctional epoxy-based crosslinking agent was mixed and stirred with the acrylic polymer solution containing 100 parts by weight of the acrylic polymer (X4) [a copolymer obtained by copolymerization of a monomer composition: 93 parts by weight of butyl acrylate (BA), 7 parts by weight of acrylic acid (AA)], as it is dissolved, to give a pressure-sensitive adhesive composition solution. The pressure-sensitive adhesive composition solution contains 100 parts by weight of the acrylic polymer (X4) and 0.02 part by weight of the tetrafunctional epoxy-based crosslinking agent.

The pressure-sensitive adhesive composition was coated on one surface of the release layer of release liner c to a thickness after drying of 25 μm, and the coated release liner was dried at 100° C. for 3 minutes, to give a pressure-sensitive adhesive sheet.

### (Evaluation)

The arithmetic mean roughness (Ra) of the surface of the release liner used (release layer surface) and the arithmetic mean roughness (Ra), release force, adhesive power, and resistance to deposition of foreign matter of the thermosetting adhesive layer in contact with the surface of the release layer in release liner in each of the thermosetting adhesive sheets and pressure-sensitive adhesive sheets obtained in Examples and Comparative Examples were determined or evaluated in accordance with to the following measurement methods or evaluation methods.

### (1) Method of Determining the Arithmetic Mean Roughness (Ra) of Release Liner Surfaces

The surface of each of the release layer of the release liners a to d used in Examples and Comparative Examples was used as the test face, and the surface opposite to the test face was bonded to a glass plate with a double-sided tape, to give a test sample. The size of the test face is width 5 cm×length 10 cm.

The arithmetic mean roughness (Ra) was determined by using “P-15” (apparatus name, manufactured by KLA-Tencor Corporation), by monitoring the surface shape of the test face in the direction from initiation to termination of coating (in the length direction (longitudinal direction)) under the condition of a load of 1 mgf and a scanning speed of 400 μm/sec. The length of measurement (evaluation length) was 4 cm. The number of measurements (N) was 2, and the average was calculated.

The test results are summarized in the column of the “arithmetic mean roughness (Ra) of release liner surface” in Table 1.

### (2) Method of Determining the Arithmetic Mean Roughness (Ra) of the Surface of Thermosetting Adhesive Layers

In the case of the thermosetting adhesive sheets obtained in Examples 1 to 3 and Comparative Examples 1 to 3, the release liner-sided surface of the thermosetting adhesive layer was used as the test face. Test samples was prepared by bonding the surface opposite to test face to a glass plate with a double-sided tape, removing the release liner and storing it at −2° C. for 2 hours. The size of the test face is width 5 cm×length 10 cm,

In the case of the pressure-sensitive adhesive sheets obtained in Comparative Examples 4 and 5, the release liner-sided surface of the pressure-sensitive adhesive layer was used as the test face. The test samples were prepared by bonding the surface opposite to test face to a glass plate with a double-sided tape, removing the release liner, discharging it by ion sputtering method for 2 minutes, and coating gold on the test face. The size of the test face is width 5 cm×length 10 cm.

The arithmetic mean roughness (Ra) was determined by using “P-15” (apparatus name, manufactured by KLA-Tencor Corporation), by monitoring the surface shape of the test face in the direction from initiation to termination of coating (in the length direction (longitudinal direction)) under the condition of a load of 1 mgf and a scanning speed of 400 μm/sec. The length of measurement (evaluation length) was 4 cm. The number of measurements (N) was 2, and the average was calculated.

The test results are summarized in the column of “arithmetic mean roughness (Ra) of thermosetting adhesive layer surface” in Table 1.

### (3) Method of Determining Release Force

The release force (N/5 cm) between the release liner and the thermosetting adhesive layer (or the pressure-sensitive adhesive layer) in each of the thermosetting adhesive sheets and pressure-sensitive adhesive sheets obtained in Examples and Comparative Examples was determined at 23° C. A typical measuring procedure will be described below.

The surface of the exposed thermosetting adhesive layer (or the pressure-sensitive adhesive layer) in the thermosetting adhesive sheet (or the pressure-sensitive adhesive sheet) was bonded to the adhesive face of single-sided adhesive tape (trade name: “No. 31B”, manufactured by Nitto Denko Corporation), and the laminate was cut to a width of 5 cm, to give a test sample. The 180° peel strength of the release liner in the test sample (tensile speed: 300 mm/minute, 23° C.; N/5 cm) was determined by using a tensile tester (apparatus name: “TCM-1kNB”, manufactured by Minebea Co., Ltd.), as the test sample was pulled from the side of the single-sided adhesive tape (No. 31B).

The test results are summarized in the column of “release force (N/5 cm)” in Table 1.

### (4) Method of Determining Adhesive Power

Of the thermosetting adhesive sheets and pressure-sensitive adhesive sheets obtained in Examples and Comparative Examples, the adhesive power (N/2 cm) of the surface of the thermosetting adhesive layer (or the pressure-sensitive adhesive layer) in contact with the release liner to polyimide was determined at 23° C. A typical measurement procedure will be described below.

The surface of the thermosetting adhesive layer (or the pressure-sensitive adhesive layer) in the thermosetting adhesive sheet (or the pressure-sensitive adhesive sheet) opposite to the release liner was bonded to the adhesive face of a single-sided adhesive tape (trade name: “No. 31B”, manufactured by Nitto Denko Corporation), and the composite sheet was cut to a width of 2 cm and the release liner was removed, to give a piece of the tape (test piece). Then, the test piece was bonded to a stainless steel plate (SUS304BA plate) (size: 10 cm×10 cm) carrying a polyimide film (trade name: “Kapton 2001”, manufactured by DU PONT-TORAY CO., LTD.) bonded to the surface thereof with a double-sided adhesive tape (trade name: “LA-50”, manufactured by Nitto Denko Corporation) in such a manner that the surface of the polyimide film and the surface of the thermosetting adhesive layer are in contact with each other, by one reciprocation of a 2-kg roller at a speed of 5 mm/second, to give a test sample.

The 180° peel adhesion of the thermosetting adhesive layer (or the pressure-sensitive adhesive layer) in the test sample to polyimide was determined by using a tensile tester (apparatus name: “TCM-1kNB”, manufactured by Minebea Co., Ltd.) and by a method of pulling the layer from the side of the single-sided adhesive tape (No. 31B) (stress rate: 100 mm/minute, 23° C.; unit: N/2 cm).

The test results are summarized in the column of “adhesive power (N/2 cm)” in Table 1.

### (5) Method of Evaluation of Resistance to Deposition of Foreign Matter

The resistance to deposition of foreign matter of the surface of the release liner-sided thermosetting adhesive layer (or the surface of pressure-sensitive adhesive layer) in each of the thermosetting adhesive sheets and pressure-sensitive adhesive sheets obtained in Examples and Comparative Examples was evaluated at 23° C. A typical measurement procedure will be described below.

The surface of the thermosetting adhesive layer (or surface of the pressure-sensitive adhesive layer) opposite to the release liner of the thermosetting adhesive sheet (or the pressure-sensitive adhesive sheet) was bonded to the adhesive face of a single-sided adhesive tape (trade name: “No. 31B”, manufactured by Nitto Denko Corporation). Then, the release liner was removed from the thermosetting adhesive sheet (or the pressure-sensitive adhesive sheet), and the sheet was placed on a horizontal table, with its exposed surface of the thermosetting adhesive layer (or the surface of pressure-sensitive adhesive layer) (size: width 5 cm×length 5 cm, area: 25 cm²) facing upward.

0.1 g of a polyvinyl chloride resin (PVC resin) having a diameter of 0.1 mm to 10 mm was sprayed on the surface of the thermosetting adhesive layer (or the surface of pressure-sensitive adhesive layer), and the thermosetting adhesive tape or sheet (or the pressure-sensitive adhesive sheet) was rotated by 180° in such a manner that the surface of the thermosetting adhesive layer (or the surface of pressure-sensitive adhesive layer) on which the PVC resin was sprayed faced downward. Subsequently, the surface of the thermosetting adhesive layer (or the surface of pressure-sensitive adhesive layer) was observed visually, and deposition of foreign matter was evaluated, as the samples without deposited PVC resin was designated as “A” (resistant to deposition of foreign matter), and the samples with deposited PVC resin as “B” (easy deposition of foreign matter).

The evaluation results are summarized in the column of “resistance to deposition of foreign matter” in Table 1.

TABLE 1

| | | | | | | Comparative | Comparative | Comparative | Comparative | Comparative |
|---|---|---|---|---|---|---|---|---|---|---|
| | | | Example 1 | Example 2 | Example 3 | Example 1 | Example 2 | Example 3 | Example 4 | Example 5 |
| Acrylic polymer | Blending amount | | 100 | 100 | 100 | 100 | 100 | 100 | 100 | 100 |
| | (parts by weight) | | | | | | | | | |
| | Monomer | BA | 70 | 60 | 68 | 70 | 66 | 68 | 93 | 93 |
| | composition | AN | 26 | 27 | 27 | 26 | 27 | 27 | — | — |
| | | AA | 4 | 4 | 5 | 4 | 4 | 5 | 7 | 7 |

| | | | | | | | | | |
|---|---|---|---|---|---|---|---|---|---|
| Etherified | Blending amount | 10 | 10 | 10 | 10 | 10 | 10 | — | — |
| phenol resin | (parts by weight) | | | | | | | | |
| Tetrafunctional | Blending amount | — | — | — | — | — | — | 0.02 | 0.02 |
| epoxy-based | (parts by weight) | | | | | | | | |
| crosslinking | | | | | | | | | |
| agent | | | | | | | | | |

| | | | | | | | | |
|---|---|---|---|---|---|---|---|---|
| Arithmetic mean roughness (Ra) of | 1.0 | 1.0 | 1.3 | 0.49 | 0.49 | 0.23 | 1.0 | 0.49 |
| release liner surface (μm) | | | | | | | | |
| Arithmetic mean roughness (Ra) of | 1.3 | 1.5 | 0.95 | 0.55 | 0.07 | 0.2 | 0.70 | 0.4 |
| thermosetting adhesive layer | | | | | | | | |
| surface (μm) | | | | | | | | |
| Release force (N/δ cm) | 0.2 | 0.16 | 0.17 | 0.15 | 0.2 | 0.16 | 1.9 | 0.54 |
| Adhesive power (N/2 cm) | 0.83 | 0.76 | 0.01 | 8.4 | 2.8 | 1.2 | 6.2 | 7.3 |
| Resistance to deposition of | A | A | A | B | B | B | B | B |
| foreign matter | | | | | | | | |

As obvious from Table 1, the surface of the thermosetting adhesive layer in the thermosetting adhesive sheet according to the present invention was resistant to deposition of foreign matter. Foreign matter deposited easily, when the arithmetic mean roughness of the surface of the release liner in contact with the thermosetting adhesive layer was too small (Comparative Examples 1 to 3).

Alternatively, in the case of pressure-sensitive adhesive tapes having a pressure-sensitive adhesive layers, there was no difference in the resistance to deposition of foreign matter between the cases where the arithmetic mean roughness of the surface of the release liner in contact with the pressure-sensitive adhesive layer is 0.6 μm or more and less than 20 μm (Comparative Example 4) and the case where it is less than 0.6 μm (Comparative Example 5), and both pressure-sensitive adhesive layers were vulnerable to deposition of foreign matter.

Exemplary preferred embodiments of the present invention will be described below.

(1) A thermosetting adhesive tape or sheet for a flexible printed circuit board including a thermosetting adhesive layer, and a release liner on at least one surface of the thermosetting adhesive layer, wherein the arithmetic mean roughness (Ra) of the at least one surface of the release liner is 0.6 μm or more and less than 20 μm and the surface (at least one surface) of the release liner having an arithmetic mean roughness (Ra) of 0.6 μm or more and less than 20 μm is in contact with the surface of the thermosetting adhesive layer.
(2) The thermosetting adhesive tape or sheet according to the above (1), wherein the 180° peel adhesion to polyimide of the surface of the thermosetting adhesive layer in contact with the surface of the release liner having an arithmetic mean roughness (Ra) of 0.6 μm or more and less than 20 μm, as determined at a tensile speed of 100 mm/minute, is 1N/2 cm or less.
(3) The thermosetting adhesive tape or sheet according to the above (1) or (2), wherein the thermosetting adhesive layer is a thermosetting adhesive layer formed with a thermosetting adhesive composition containing an acrylic polymer (X) and a thermosetting resin (Y).
(4) The thermosetting adhesive tape or sheet according to any one of the above (1) to (3), wherein the release force between the release liner and the thermosetting adhesive layer, as determined at a tensile speed of 300 mm/minute, is 0.3 N/5 cm or less.
(5) The thermosetting adhesive tape or sheet according to any one of the above (1) to (4), wherein the surface of the thermosetting adhesive layer in contact with the surface of the release liner having an arithmetic mean roughness (Ra) of 0.6 μm or more and less than 20 μm has an arithmetic mean roughness (Ra) of 0.7 μm or more and less than 20 μm.
(6) The thermosetting adhesive tape or sheet according to any one of the above (1) to (5), wherein the release liner is a release liner without silicone treatment.

### REFERENCE SIGNS LIST

1 Release liner A
   11 Release face
   12 Rear release face (or rear face)
2 Adhesive body
   21 Adhesive face a
   22 Adhesive face b
3 Release liner B
   31 Release face
   32 Rear face

1. A thermosetting adhesive tape or sheet for a flexible printed circuit board comprising:
a thermosetting adhesive layer, and
a release liner on at least one surface of the thermosetting adhesive layer;
wherein the arithmetic mean roughness (Ra) of the at least one surface of the release liner is 0.6 μm or more and less than 20 μm and the surface (at least one surface) of the release liner having an arithmetic mean roughness (Ra) of 0.6 μm or more and less than 20 μm is in contact with the surface of the thermosetting adhesive layer.

2. The thermosetting adhesive tape or sheet according to claim 1, wherein the 180° peel adhesion to polyimide of the surface of the thermosetting adhesive layer in contact with the surface of the release liner having an arithmetic mean roughness (Ra) of 0.6 μm or more and less than 20 μm, as determined at a tensile speed of 100 mm/minute, is 1N/2 cm or less.

3. The thermosetting adhesive tape or sheet according to claim 1, wherein the thermosetting adhesive layer is a thermosetting adhesive layer formed with a thermosetting adhesive composition containing an acrylic polymer (X) and a thermosetting resin (Y).

4. The thermosetting adhesive tape or sheet according to claim 1, wherein the release force between the release liner and the thermosetting adhesive layer, as determined at a tensile speed of 300 mm/minute, is 0.3 N/5 cm or less.

5. The thermosetting adhesive tape or sheet according to claim 1, wherein the surface of the thermosetting adhesive layer in contact with the surface of the release liner having an arithmetic mean roughness (Ra) of 0.6 μm or more and less than 20 μm has an arithmetic mean roughness (Ra) of 0.7 μm or more and less than 20 μm.

6. The thermosetting adhesive tape or sheet according to claim 1, wherein the release liner is a release liner without silicone treatment.

7. The thermosetting adhesive tape or sheet according to claim 2, wherein the thermosetting adhesive layer is a thermosetting adhesive layer formed with a thermosetting adhesive composition containing an acrylic polymer 00 and a thermosetting resin (Y).

8. The thermosetting adhesive tape or sheet according to claim 2, wherein the release force between the release liner and the thermosetting adhesive layer, as determined at a tensile speed of 300 mm/minute, is 0.3 N/5 cm or less.

9. The thermosetting adhesive tape or sheet according to claim 3, wherein the release force between the release liner and the thermosetting adhesive layer, as determined at a tensile speed of 300 mm/minute, is 0.3 N/5 cm or less.

10. The thermosetting adhesive tape or sheet according to claim 7, wherein the release force between the release liner and the thermosetting adhesive layer, as determined at a tensile speed of 300 mm/minute, is 0.3 N/5 cm or less.

11. The thermosetting adhesive tape or sheet according to claim 2, wherein the surface of the thermosetting adhesive layer in contact with the surface of the release liner having an arithmetic mean roughness (Ra) of 0.6 μm or more and less than 20 μm has an arithmetic mean roughness (Ra) of 0.7 μm or more and less than 20 μm.

12. The thermosetting adhesive tape or sheet according to claim 3, wherein the surface of the thermosetting adhesive layer in contact with the surface of the release liner having an arithmetic mean roughness (Ra) of 0.6 μm or more and less than 20 μm has an arithmetic mean roughness (Ra) of 0.7 μm or more and less than 20 μm.

13. The thermosetting adhesive tape or sheet according to claim 4, wherein the surface of the thermosetting adhesive layer in contact with the surface of the release liner having an arithmetic mean roughness (Ra) of 0.6 μm or more and less than 20 μm has an arithmetic mean roughness (Ra) of 0.7 μm or more and less than 20 μm.

14. The thermosetting adhesive tape or sheet according to claim 7, wherein the surface of the thermosetting adhesive layer in contact with the surface of the release liner having an arithmetic mean roughness (Ra) of 0.6 μm or more and less than 20 μm has an arithmetic mean roughness (Ra) of 0.7 μm or more and less than 20 μm.

15. The thermosetting adhesive tape or sheet according to claim 8, wherein the surface of the thermosetting adhesive layer in contact with the surface of the release liner having an arithmetic mean roughness (Ra) of 0.6 μm or more and less than 20 μm has an arithmetic mean roughness (Ra) of 0.7 μm or more and less than 20 μm.

16. The thermosetting adhesive tape or sheet according to claim 9, wherein the surface of the thermosetting adhesive layer in contact with the surface of the release liner having an arithmetic mean roughness (Ra) of 0.6 μm or more and less than 20 μm has an arithmetic mean roughness (Ra) of 0.7 μm or more and less than 20 μm.

17. The thermosetting adhesive tape or sheet according to claim 10, wherein the surface of the thermosetting adhesive layer in contact with the surface of the release liner having an arithmetic mean roughness (Ra) of 0.6 μm or more and less than 20 μm has an arithmetic mean roughness (Ra) of 0.7 μm or more and less than 20 μm.

18. The thermosetting adhesive tape or sheet according to claim 2, wherein the release liner is a release liner without silicone treatment.

19. The thermosetting adhesive tape or sheet according to claim 3, wherein the release liner is a release liner without silicone treatment.

20. The thermosetting adhesive tape or sheet according to claim 4, wherein the release liner is a release liner without silicone treatment.
